(19) United States
(12) Patent Application Publication
(10) Pub. No.: US 2009/0258106 A1
(43) Pub. Date: Oct. 15, 2009

(54) Corn Wet Milling Process

(76) Inventors: Robert Jansen, Portela (PT); David Sass, Loudon, TN (US); Gordon Walker, Oxfordshire (GB); Eric Lutz, Decatur, IL (US)

Correspondence Address: WILLIAMS, MORGAN & AMERSON, 10333 RICHMOND, SUITE 1100, HOUSTON, TX, 77042, US

(21) Appl. No.: 11/917,915

(22) PCT Filed: Jul. 14, 2006
(86) PCT No.: PCT/US06/27296

§ 371 Date: Jun. 9, 2009

Related U.S. Application Data
(63) Continuation-in-part of application No. 11/185,527, filed on Jul. 20, 2005.

(51) Int. Cl. A23L 1/105; C13K 1/06; C12C 11/07; A23L 1/186; C12C 3/12; C13K 1/02; A23K 1/12; A23L 1/10; C12H 1/14

(52) U.S. Cl. 426/2; 426/48; 426/13; 426/28; 426/30; 426/29; 426/539; 426/627; 426/592

(57) ABSTRACT

A corn wet-milling process comprises steeping corn kernels in an aqueous liquid, which produces softened corn; milling the softened corn in a first mill, which produces a first milled corn; separating germ from the first milled corn, thereby producing a germ-depleted first milled corn; milling the germ-depleted first milled corn in a second mill, producing a second milled corn; separating the second milled corn into a first starch/protein portion that comprises starch and protein and a first fiber portion that comprises fiber, starch, and protein; milling the first fiber portion in a third mill, which produces a milled fiber material that comprises fiber, starch, and protein; separating at least some of the starch and protein in the milled fiber material from the fiber therein, producing a second fiber portion that comprises fiber and starch and a second starch/protein portion that comprises starch and protein; and contacting the second fiber portion with at least one enzyme to convert at least some of the starch therein to dextrose. The converted material is screened using one or more screens to separate the fiber from the liquor. The liquor can be fermented to ethanol, or refined to dextrose. The fiber can be pressed and dried as an animal feed.

### BACKGROUND OF THE INVENTION

Corn kernels contain starch, protein, fiber, and other substances which can be separated to make various useful products. The conventional process for wet milling corn involves steeping the corn in water containing sulfur dioxide. The softened corn is then milled to allow the separation of the four main components: starch, protein, fiber, and germ. In the conventional process, the corn is typically milled with three different mills, each one grinding more finely than the previous one. After the first (coarsest) milling step, the germ can be removed. The second grind step loosens germ that was not released by the first step, and more germs are removed. After the second milling step, a screen is typically used to separate the free starch from the fiber. The fiber fraction is milled in a third milling step, and then washing with screens is used to remove a residual starch fraction from the fiber. The starch fraction can then be centrifuged to separate the protein therein from the starch.

In order to separate starch and protein from the fiber after the third milling, it is common to use a series of screens, sometimes as many as seven screens, with a counter-current flow of water. The aim is to separate the unbound starch and protein from the fiber, and the greater the number of screens and the greater the volume of water used, the more complete the separation tends to be. Economic removal of protein can usually be obtained with fewer screens than can the economic removal of starch. Because some starch remains bound to the fiber, and there is a practical limit to the number of screens and the volume of water that can be used, there is always some loss of starch with the fiber product. The fiber product is usually dried and sold as animal feed. The value of this product is considerably less than the value of the starch. In many instances, the fiber product of the corn wet milling process contains 15-30 wt % starch, and this represents a loss of yield of starch that can potentially be converted to dextrose.

There is a need for alternative or improved processes that can recover starch to a greater extent or more economically.

A separate problem that exists is finding suitable protein sources for feeding fish. Within the fish feed industry, fish meal has historically been the protein source of choice in feed formulations. However, fish meal for feed formulations is in relatively short supply and is relatively expensive. Thus there is a need for alternative protein sources. Vegetable proteins are one potential source, but many vegetable proteins are not sufficiently high in protein content or quality to provide the digestible protein uptake required by fish. Furthermore, some of the vegetable proteins which have a high protein density also contain pigments which can cause undesirable coloration of the flesh of the fish fed on these protein sources.

There are currently three main vegetable sources of concentrated protein that are commercially available in sufficient quantity and could be used in fish feed formulations for carnivorous fish. These are corn gluten meal (CGM), vital wheat gluten (VWG), and soya protein. While each of these products has a high protein content, they each have drawbacks which limits their use in fish feed formulations.

Corn gluten meal has been evaluated as a substitute for fish meal in fish feed formulations with limited success. The use of over 15% corn gluten meal in trout feed can cause a yellowing of the flesh. As a result, most trout feed manufacturers limit the amount of CGM in their feeds to 5%, or avoid its use altogether. The yellow pigmentation in CGM is due to the presence of xanthophylls. This pigment is highly desirable in some feeds (e.g., chicken) but it is often undesirable in fish formulations. A further problem reported with CGM in fish feed formulations is that phosphorous availability is low.

Vital wheat gluten (VWG) is a widely available vegetable protein source. In fish feed applications, VWG carries the potential advantage that it is relatively unpigmented when compared to CGM, particularly with regard to yellow pigmentation. VWG does not contain high levels of xanthophylls. Thus, the flesh of fish fed on VWG would not be expected to become undesirably pigmented. However, the use of VWG in fish feeds is limited to relatively low levels (5-8%) because when VWG is incorporated into fish feed formulations at higher levels and extruded or pelleted, the resulting pellets are too hard for fish to consume. Further, inclusion of VWG in the feed formulation leads to an increase in the viscosity of the extruder feed and the extruder tends to block when VWG is included at high levels. This problem is believed to be a result of the inherent “vitality” of VWG. This problem limits the use of VWG as a substitute for fish meal.

Soya protein concentrate is a third potential vegetable protein that could be used in fish feed applications for carnivorous fishes. However, it can only be used in a relatively low percentage due to its anti-nutritive properties in fish feed applications. Furthermore, it has been shown that soya protein has a lower digestibility for carnivorous fishes like salmon than vital wheat gluten and corn gluten meal.

There remains a need for a vegetable protein source that can be used in fish feed applications.

### SUMMARY OF THE INVENTION

One aspect of the invention is a process that comprises steeping corn kernels in an aqueous liquid, which produces softened corn; milling the softened corn in a first mill, which produces a first milled corn; and separating germ from the first milled corn, thereby producing a germ-depleted first milled corn. (“Depleted” means that the germ content has been reduced, but not necessarily that no germ at all is present.) The process also comprises milling the germ-depleted first milled corn in a second mill, producing a second milled corn, from which optionally further germ separation can occur; and separating the second milled corn, after the optional second germ recovery, into a first starch/protein portion that comprises starch and protein and a first fiber portion that comprises fiber, starch, and protein. The process further includes milling the first fiber portion in a third mill, which produces a milled fiber material that comprises fiber, starch, and protein. At least some of the starch and protein in the milled fiber material is separated from the fiber therein, producing a second fiber portion that comprises fiber and starch and a second starch/protein portion that comprises starch and protein. The second fiber portion is contacted with at least one enzyme to convert at least some of the starch therein to dextrose.

In some embodiments of the invention, at least some of the dextrose produced as described above can be converted to ethanol by fermentation. In other embodiments, the dextrose can be combined with dextrose produced elsewhere in the process.

In the embodiments of the invention in which ethanol is produced by fermentation, the fermentation also produces beer still bottoms, and the process optionally can also comprise separating fiber from the beer still bottoms to produce a defibered beer still bottoms, and membrane filtering the defibered beer still bottoms to produce a protein-rich retentate and a permeate. A protein-rich composition can be recovered from the retentate. The proportion of insoluble protein in the beer still bottoms can be enhanced by adjusting the pH of the beer still bottoms to about 2 to 7, preferably about 3 to 6, more preferably about 3.5 to 5, before the membrane filtration, and/or adding multivalent cations to the beer still bottoms before the membrane filtration.

In one embodiment of the process, at least some of the starch in the second fiber portion is at least partially liquefied by alpha amylase, and then at least partially saccharified by amyloglucosidase. These steps convert at least some of the starch in the second fiber portion to saccharides such as dextrose. Thus the result of this conversion is a material comprising dextrose and fiber. The fiber in this material can be separated by washing with at least one screen, which produces a dextrose-depleted fiber material and a dextrose-rich material. It should be understood that the “starch-depleted fiber material” can still contain some starch, but will contain a much lower concentration of starch on a dry solids basis than the material before the separation.

In one embodiment, the first starch/protein portion produced after the second mill can be separated into a starch-rich material and a protein-rich material. The starch-rich material can be converted enzymatically into dextrose. The dextrose produced in this part of the process can be combined with the dextrose produced as described in previous paragraphs.

In one embodiment of the invention, the separation of the milled fiber material into a second starch/protein portion and a second fiber portion comprises washing with screens. The number of screens used for this separation is determined primarily by the desired recovery of protein and secondarily by the desired recovery of starch. For example, in some embodiments of the process, the number of screens used to separate the milled fiber material into a second starch/protein portion and a second fiber portion is no greater than three. As a result, the second fiber portion will still usually contain a significant concentration of starch, which can be converted to dextrose prior to separation from the fiber, as described above. For example, in one embodiment of the process, the second fiber portion comprises about 15-60 wt % starch on a dry solids basis.

In another embodiment of the invention, the steeping of corn kernels in an aqueous liquid also produces an aqueous steep liquor that contains protein, and protein is recovered from the aqueous steep liquor by membrane filtration.

Another aspect of the invention is a method of recovering protein from beer still bottoms. The method comprises providing a dextrose-containing composition derived from corn, fermenting the dextrose-containing composition to produce ethanol and beer still bottoms, separating fiber from the beer still bottoms to produce a defibered beer still bottoms, and membrane filtering the defibered beer still bottoms to producing a protein-rich retentate and a permeate. A depigmented, protein-rich composition can be recovered from the retentate.

Another aspect of the invention is a corn-derived, depigmented protein composition produced by any of the above-described processes.

Yet another aspect of the invention is a method of feeding fish, which comprises feeding a corn-derived, depigmented protein composition produced by any of the above-described processes to animals such as fish.

### BRIEF DESCRIPTION OF THE DRAWINGS

FIG. 1 is a process flow diagram of one embodiment of the invention.

FIG. 2 is a process flow diagram of another embodiment of the invention.

FIG. 3 is a process flow diagram of the process used in Example 1.

### DESCRIPTION OF ILLUSTRATIVE EMBODIMENTS

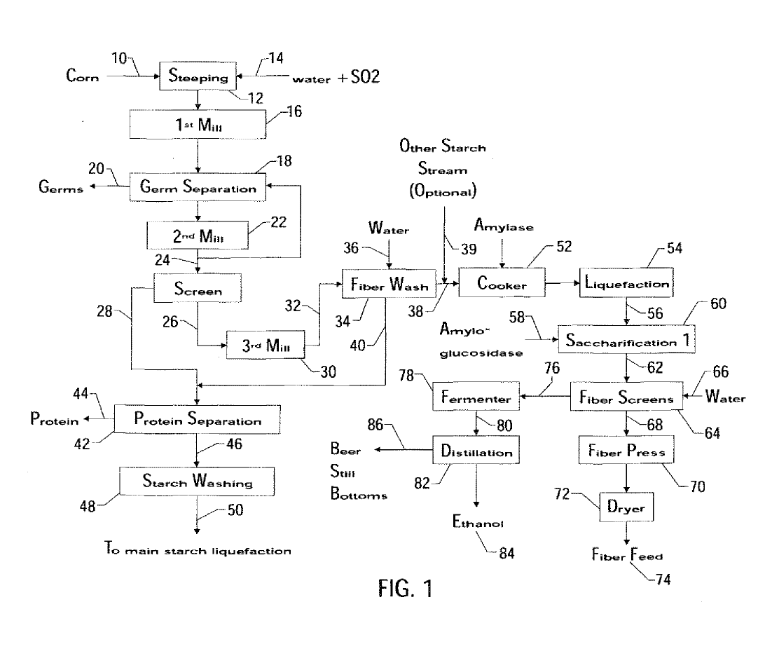

FIG. 1 shows one embodiment of the present invention. In this embodiment, corn is separated and processed into germ, protein, starch, ethanol, and fiber.

The feed 10 to the process is corn. A variety of types of corn can be used, including dent, high amylose and waxy corn. The corn is fed into a steep tank 12 which also contains water 14. Sulfur dioxide is typically added to the steep tank. The steeping system can be either batch or continuous and the residence time of the corn can be from 12 to 48 hours. The temperature during the steep is in the range 45 to 55° C. (113-131° F.). The product of the steeping step is softened corn and the liquid fraction produced is called steep liquor.

It is possible to recover protein from the steep liquor by membrane filtration, for example by microfiltration or ultrafiltration. Suitable apparatus and process conditions for doing this are described in U.S. Pat. No. 5,773,076, which is incorporated here by reference.

The softened corn kernels are then milled in a first mill 16 to produce a first milled corn. This relatively coarse milling allows the germ 20 to be separated 18 from the rest of the kernel. Oil can be removed from the germ and refined to make corn oil. The residual cake, after oil removal, of the germ can be dried to make corn germ meal, or it can be used as an ingredient in corn gluten feed.

After the germ is removed, the remainder of the kernel is milled 22 a second time to produce a second milled corn 24. This second milling, which is much the same as the first, loosens germs that were not caught by the first grinding mill. After the second germ recovery step, this second milled corn 24 is then passed through a screen to separate it into a first fiber portion 26 and a first starch/protein portion 28. The first fiber portion 26 comprises fiber, starch, and protein, and the first starch/protein portion 28 comprises starch and protein. The first fiber portion 26 is then milled a third time. This third grinding step pulverizes endosperm particles in the corn kernels while leaving the fibrous material nearly intact. The relatively finely milled fiber material 32 produced by the third mill 30 is then screened and washed 34 with water 36 or a recycled aqueous process stream, to separate residual starch and protein from the fiber. In one embodiment of the invention, this washing is performed with an aqueous stream that is largely depleted of saccharides as a result of processing. This separation step 34 produces a second fiber portion 38 and a second starch/protein portion 40. The second fiber portion comprises fiber and starch, and the second starch/protein material comprises protein and starch.

In contrast to the screening and washing used in a conventional corn wet milling process, the number of fiber wash screens can be reduced down to the level needed to recover the desired amount of protein from the fiber. In other words, the number of screens used can be sufficient to achieve a desirable low level of residual protein in the second fiber portion 38, even though that material 38 may still contain additional recoverable starch. Unlike the conventional process, it is not necessary to wash the second fiber portion further to obtain more complete recovery of starch, because the process provides other means for recovery of the starch downstream.

In some embodiments of the process, if the yield of protein is not considered important this screening step can be eliminated. More usually, the number of fiber wash screens can be as few as three. Similarly, the amount of wash water (or other aqueous process stream used for this purpose) can also be reduced. The second fiber portion 38 after washing can contain, in some embodiments of the process, 15-60 wt % starch on a dry solids basis (d.s.b.).

The second starch/protein portion 40 can be combined with the first starch/protein portion 28, and then subjected to a separation 42 operation, for example by centrifugation, to produce a protein-rich material 44 and a starch-rich material 46. The starch-rich material can be washed 48 to further purify it. The resulting starch 50 can be dried to produce corn starch, or can undergo further processing. For example, the starch can be hydrolyzed to produce dextrose, which can in turn be used in fermentation to produce ethanol or organic acids, or the dextrose can be converted by enzymatic treatment to high fructose corn syrup.

The second fiber portion 38, which as mentioned above still contains a significant amount of starch, is then cooked in a starch cooker 52. However, optionally another source of starch 39 can be added at this point, and if necessary diluted with a low solids recycle process steam, or water to bring the dry solids into the range of 15 to 35%, preferably about 25%. The reason for adding another starch stream will depend on the quantity of either dextrose or ethanol required from the process. Before cooking begins, the pH of the material can be adjusted to about 5.0-6.0, preferably to about 5.6, and alpha amylase can be added. Preferably the moisture content is adjusted prior to or during the cooking step such that the dry solids content is about 15-35%, preferably about 25%, by using water, preferably process waters. A number of suitable starch cookers are known in the industry, such as jet cookers. Typical temperatures for the starch cooking step are 70-110° C. (158-230° F.). The residence time in the cooker can vary, but in many cases will be about 5-10 minutes. The product from the cooker 52 can then be held in liquefaction tanks 54, for example for about 2-3 hours, to allow liquefaction of the starch by the alpha amylase to proceed.

The temperature of the liquefied material 56 is then reduced to about 60° C., the pH adjusted to about 4.2, and amyloglucosidase enzyme 58 is added. The liquefied material can be held for about 2 to 10 hours to allow saccharification 60 to start and the viscosity to be reduced. This partially-saccharified slurry 62 is then screened 64 to remove fiber. This can be done in a number of stages, using water 66 or a suitable recycled aqueous process stream to wash the sugars from the fiber in a counter-current manner. This water or recycled stream can be added in the final screen, with the wash water then progressing to the first screen. Suitable types of screens include DSM screens and centrifugal screens. The number of screen stages can vary from 1-7, based on the recovery requirements.

The washed fiber 68 can be pressed, for example in a screw press 70, and then dried 72, milled, and recovered 74. This fiber product can be used in a variety of ways to make valuable co-products. For example, the fiber can be processed to at least partially hydrolyze cellulose and hemi-cellulose components; the resulting hydrolysate can be fermented to produce, for example, ethanol. Alternatively, the fiber can be hydrolyzed to one or more of dextrose, xylose and arabinose. An alternative use for this fiber is as an animal feed, and a further possible use is as a biofuel. Clearly the wet fiber will be optimally used in some of these cases and the dry fiber in other cases.

The saccharide-rich liquid material 76 from the screens can be treated in at least two ways. If dextrose syrup is a desired product, then additional amyloglucosidase can be added to the material 76 in tanks (not shown in FIG. 1.) The total saccharification time in these tanks can typically be 24-48 hours. The fully saccharified liquor can then be added back to a dextrose stream produced from the starch 50 in the main process line, giving an enhanced yield of dextrose.

An alternative use of this dextrose-rich stream 76 is to use it as a fermentation feedstock. This stream is suitable for a number of fermentations by choosing a suitable microbe. In one particular fermentation, as shown in FIG. 1, the liquid stream can be fermented to produce ethanol. The saccharide-rich material 76 can be placed in a fermenter 78 with a microorganism that can produce ethanol. Suitable microorganisms for this purpose include Saccharomyces cerevisiae, Saccharomyces carlsbergiensis, Kluyveromyces lactis, Kluyveromyces fragilis, and any other microorganism that makes ethanol. Additional amyloglucosidase enzyme may be added, but residual amyloglucosidase enzyme from the saccharification step 60 is often sufficient to continue saccharification during fermentation. Preferably the pH is adjusted to about 4 and the temperature adjusted to about 28° C. As a result of the fermentation, most or all of the dextrose in the material 76 is converted to ethanol. The ethanol 84 can be separated from the fermentation broth 80 in a distillation unit 82. Suitable distillation temperatures can be about 60-120° C. The distillation also produces a stream that is typically referred to as beer still bottoms 86. This stream can be filtered (e.g., using ultra or micro filtration) to produce a clear permeate stream free of suspended solids and a protein rich retentate stream that can be used as an animal feed. Optimally, the clear permeate stream can be anaerobically digested very efficiently (using for example EGSB (Expanded Granular Sludge Bed) technologies or some similar digestion process. This generates a valuable co-product stream of biogas which can be used as an energy source on the plant.

Optionally, the ethanol can then be subjected to rectification and dehydration to produce a fuel-grade ethanol product. Another option is to produce potable ethanol by rectification.

The process of the present invention can be performed on a batch, semi-batch, or continuous basis, or some combination thereof. For example, certain steps can be performed on a batch basis while other steps are performed continuously in the same process.

Certain embodiments of the process of the present invention provide a greater yield of dextrose or ethanol than a conventional corn wet milling process. In comparison to a dry milling process which produces ethanol, certain embodiments of the present process achieve a similar yield of ethanol but provide a better yield of germ and protein, similar to that achieved in convention wet milling processes.

The fiber produced in the present process contains less starch than the fiber produced by a convention wet milling process. This may allow the fiber to be used in areas other than animal feed.

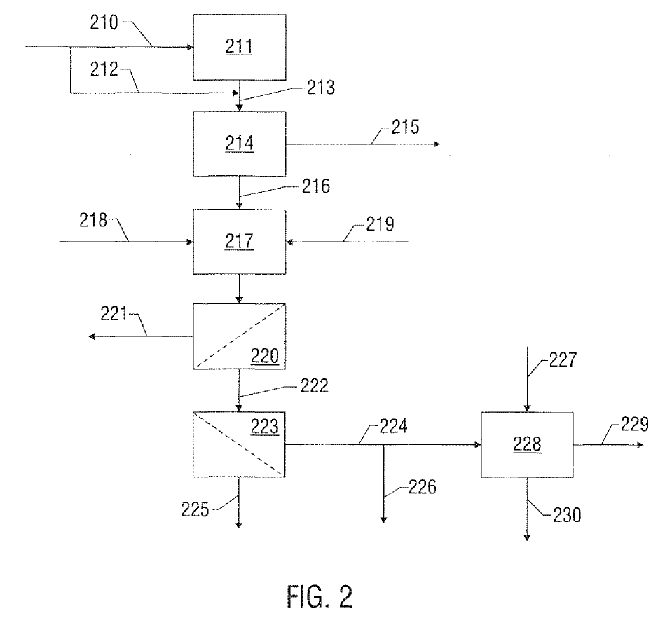

Another embodiment of the invention is shown in FIG. 2. In this embodiment, the beer still bottoms produced by fermentation can be further processed to yield a protein product having relatively low color. The beer still bottoms stream typically contains soluble and insoluble proteins (including yeast bodies from the fermentation), as well as ash, fat and fiber. The amount of protein recovered can be enhanced by conversion of some of the soluble protein into insoluble protein. This can be done by one or more of: pH adjustment of the filter feed, addition of multivalent cations (e.g., Ca²⁺), and metabolism of soluble protein by the yeast and subsequent recovery of the protein in an insoluble form in the yeast cells.

As shown in FIG. 2, part of a stream 210 from a wet milling plant that comprises saccharides and some protein is fed to a yeast propagation system 211, while the remainder 212 of that stream by-passes the propagators and is combined with the product from the propagators 213. This combined stream forms the feed to a fermentation unit operation 214, the products of which are ethanol 215 and beer still bottoms 216. The beer still bottoms 216 are passed into a suitable vessel 217 and optimally pH adjusted 218 to about 2 to 7, preferably about 3 to 6, more preferably about 3.5 to 5. Protein desolubilizing reagents 219, such as divalent cations, can be added as required.

The product stream from the vessel 217 is separated, for example by a sieve 220, to produce fibers 221 and a substantially de-fibered stream 222. The de-fibered stream is membrane filtered 223, for example by ultrafiltration or microfiltration, to generate a retentate stream 224 and a permeate stream 225. The permeate stream is typically sent for waste water treatment. The retentate stream 224, which is relatively rich in protein, can be dried and used as animal feed 226, or further water 227 can be added to it and it can be diafiltered 228 to produce a protein-rich washed retentate 229 and a further permeate 230. The content of the protein-rich product makes it suitable for inclusion in corn gluten meal.

The protein-rich product (226 or 229) produced by this version of the process is relatively de-pigmented when compared with standard corn gluten meal. Without wishing to be bound by theory, it appears that the xanthophylls (yellow color pigment in corn) are extracted from the protein by the ethanol that is produced during the fermentation stage. It also appears that much of the residual xanthophylls in the beer still bottoms end up in the permeate stream 225.

As mentioned above, the protein-rich product of this process is a vegetable protein composition which can provide a high density, high quality protein source for fish (such as salmonids) without undesirable pigmentation, binding, or anti-nutritive problems that are associated with other vegetable proteins like conventional corn gluten meal, vital wheat gluten, or soy protein.

This vegetable protein composition allows a higher incorporation rate in extruded fish foods because it is relatively non-binding, so that the feed can be extruded without blocking the extruder due to excessive viscosity. Thus the vegetable protein composition can be formed into pellets that are not so hard so as to be unpalatable to the fish. The vegetable protein composition does not contain substantial amounts of anti-nutritional factors that would decrease digestibility or contribute anti-nutritive properties to the feed.

This vegetable protein composition provides a method of feeding animals such as carnivorous fish (e.g. salmonids), in which the vegetable protein composition can be used at a high protein concentration. Optionally, the feed composition can be supplemented with pigments (e.g. astaxanthin) which will augment the desired coloration of the flesh of the animal that eats the feed.

Various embodiments of the invention can be further understood from the following examples.

### Example 1

530 g of fiber from the third fiber wash screen after the third mill were collected from a corn wet mill. This fiber material had a dry solids concentration of 25%. To this were added two liquid streams, again from the corn wet mill. The first of these were 205 g of light steep water containing mainly ash and soluble protein with a dry solids concentration of 12%. The second was 265 g of primary centrifuge underflow, which is primarily starch and has a dry solids concentration of 40%. The primary centrifuge underflow was added to make the test representative in relation to the way a plant would be run. More starch than was present in the fiber may be required for fermentation to ethanol, and the steep water was added to bring the dry solids to about 27%.

Potassium hydroxide was added to reach pH 5.6, and 1.25 g of Liquizyme Supra was added. This is an alpha-amylase enzyme supplied by Novozymes. The sample was mixed well and then split into two equal samples of 500 g each. One of the samples was heated to 81° C. (178° F.) on a hot plate and held at this temperature for 45 minutes with agitation. At this point 50 g of the other unheated sample was added, and agitation continued for a further 30 minutes. The temperature was then increased to 98° C. (208° F.) and held for a further 45 minutes. This procedure was used to make the test similar to a continuous recycle system round the starch cooker.

The sample was then removed from the hot plate, and with continued mixing hydrochloric acid was added to bring the pH down to pH 4.3. The sample was then cooled to 63° C. (145° F.) as quickly as possible. Then 0.05 g of Spirozyme Plus enzyme, an amyloglucosidase enzyme supplied by Novozymes was added; the sample was agitated and maintained at 63° C. for 6 hours.

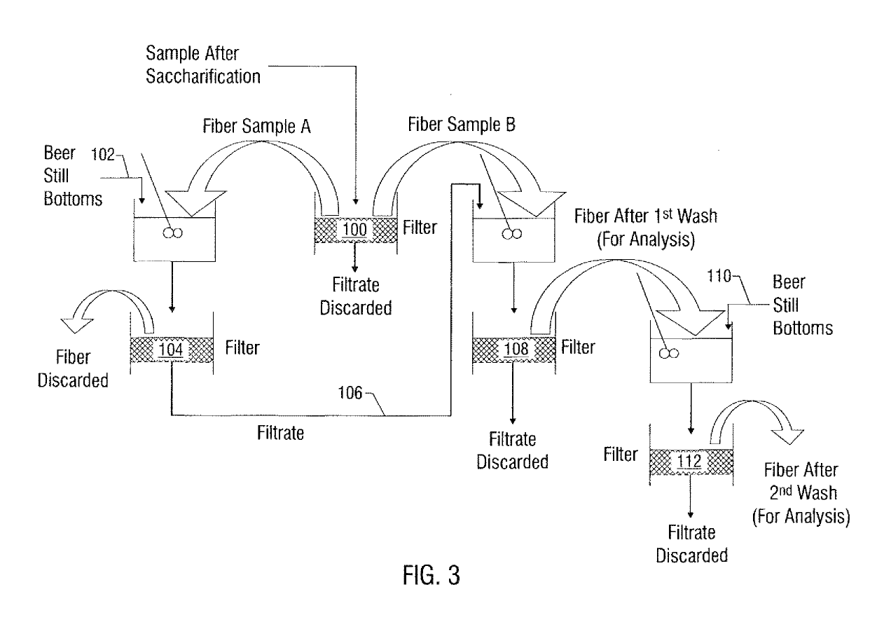

The method used for this sample is shown in FIG. 3.

The sample was first filtered on a vacuum filter 100, and was then split into two equal amounts by weight. One of these samples (sample A) was then mixed with 226 g of beer still bottoms 102, a stream from the distillery. This stream is a low solids stream containing ash and protein with a dry solids concentration of about 8%, and is the typical stream that would be used in a factory operation. The mixture of fiber and beer still bottoms was filtered 104 under vacuum, and the filtrate 106 from this first wash was collected.

Then the second half of the fiber sample (sample B) was mixed with this filtrate 106 from the first wash, and filtered 108 under vacuum. This fiber was analyzed for starch and dextrose, and the results are shown in Table 1 as “Fiber—After 1^{st} Wash”. Then this fiber was washed again by mixing with fresh beer still bottoms 110 and filtered 112. The fiber from this second wash was analyzed for starch and dextrose and the results given in Table 1 as “Fiber—After 2^{nd} Wash”.

The liquid recovered from the fiber wash can be cooled and fermented to ethanol. The washed fiber can be pressed and dried.

TABLE 1

| | Dextrose in Fiber % | Starch in Fiber % |
|---|---|---|
| Fiber - After 1^{st} Wash | 15.5 | 6.0 |
| Fiber - After 2^{nd} Wash | 9.3 | 6.7 |

The results in Table 1 show that the dextrose in the fiber can be reduced considerably by two washes. It would be expected that further washes would give a greater reduction. The starch remaining in the fiber is probably bound to the fiber, and would not be expected to reduce with further washing.

### Example 2

A process of the present invention was used in a pilot plant with European corn, and the following product streams were analyzed: a wet fiber stream (corresponding to stream 68 in FIG. 1), a dry fiber stream (corresponding to stream 74 in FIG. 1), and a beer still bottoms permeate (corresponding to stream 225 in FIG. 2). Table 2 below summarizes the analyses.

TABLE 2

| Stream | DS | Protein | Ash | Sugars | Fat |
|---|---|---|---|---|---|
| Wet fibers | 37.7% | 12.3% | 1.0% | NA | 7.0% |
| Dry fibers | 93.9% | 13.7% | 1.4% | NA | 8.7% |
| Beer still | 3.9% | 12.9% | 31.1% | 3.3% | 0.5% |
| bottoms | | | | | |
| permeate | | | | | |

DS is dry solids. Protein, ash, sugars, and fat are quoted as a % on dry solids. NA = Not available.

The preceding description is not intended to be an exhaustive list of every possible embodiment of the present invention. Persons skilled in the art will recognize that modifications could be made to the embodiments described above which would remain within the scope of the following claims.

1. A process comprising:
steeping corn kernels in an aqueous liquid, producing softened corn;
milling the softened corn in a first mill, producing a first milled corn;
separating germ from the first milled corn, producing a germ-depleted first milled corn;
milling the germ-depleted first milled corn in a second mill, producing a second milled corn;
recovering additional germ from the second milled corn;
separating the second milled corn into a first starch/protein portion that comprises starch and protein and a first fiber portion that comprises fiber, starch, and protein;
milling the first fiber portion in a third mill, producing a milled fiber material that comprises fiber, starch, and protein;
separating at least some of the starch and protein from the fiber in the milled fiber material, producing a second fiber portion that comprises fiber and starch and a second starch/protein portion that comprises starch and protein; and
contacting the second fiber portion with at least one enzyme to convert at least some of the starch therein to dextrose.

2. (canceled)

3. The process of claim 1, further comprising fermenting the dextrose with a microbe.

4. The process of claim 1, further comprising converting at least some of the dextrose to ethanol by fermentation.

5. The process of claim 1, wherein at least some of the starch in the second fiber portion is at least partially liquefied by alpha amylase and is at least partially saccharified by amyloglucosidase, producing a material comprising dextrose and fiber.

6. The process of claim 5, further comprising separating fiber from dextrose by washing the material that comprises dextrose and fiber with at least one screen, producing a dextrose-depleted fiber material and a dextrose-rich material.

7. The process of claim 6, further comprising at least partially hydrolyzing at least one of cellulose and hemi-cellulose components in the dextrose-depleted fiber material, thereby producing a fiber hydrolysate.

8. The process of claim 7, further comprising fermenting the fiber hydrolysate to produce ethanol.

9. The process of claim 6, further comprising at least partially hydrolyzing at least one of cellulose and hemi-cellulose components in the dextrose-depleted fiber material, thereby producing at least one of dextrose, xylose, or arabinose.

10. The process of claim 1, further comprising separating the first starch/protein portion into a starch-rich material and a protein-rich material.

11. The process of claim 10, further comprising enzymatically converting at least some of the starch-rich material into dextrose.

12. The process of claim 1, wherein the separation of the milled fiber material into a second starch/protein portion and a second fiber portion comprises washing with screens.

13. The process of claim 12, wherein the number of screens used to separate the milled fiber material into a second starch/protein portion and a second fiber portion is determined primarily by the desired recovery of protein and secondarily by the desired recovery of starch.

14. The process of claim 13, wherein the second fiber portion comprises about 15-60 wt % starch on a dry solids basis.

15. The process of claim 1, further comprising adding a starch-containing stream to the second fiber portion prior to contacting the second fiber portion with at least one enzyme to convert at least some of the starch therein to dextrose.

16. The process of claim 1, wherein the steeping of corn kernels in an aqueous liquid also produces an aqueous steep liquor that contains protein, and wherein the process further comprises recovering protein from the aqueous steep liquor by membrane filtration.

17. The process of claim 4, wherein the fermentation also produces beer still bottoms, and wherein the process further comprises:
separating fiber from the beer still bottoms, producing a defibered beer still bottoms; and
membrane filtering the defibered beer still bottoms, producing a protein-rich retentate and a permeate.

18. The process of claim 17, further comprising anaerobically digesting the permeate to produce biogas.

19. The process of claim 17, further comprising recovering a protein-rich composition from the retentate.

20. The process of claim 17, further comprising adjusting the pH of the beer still bottoms to about 2-7 before the membrane filtration.

21. The process of claim 17, further comprising adding multivalent cations to the beer still bottoms before the membrane filtration.

22. The process of claim 17, further comprising diafiltering the retentate.

23. A process comprising:
steeping corn kernels in an aqueous liquid, producing softened corn;
milling the softened corn in a first mill, producing a first milled corn;
separating germ from the first milled corn, producing a germ-depleted first milled corn;
milling the germ-depleted first milled corn in a second mill, producing a second milled corn;
separating the second milled corn into a first starch/protein portion that comprises starch and protein and a first fiber portion that comprises fiber, starch, and protein;
milling the first fiber portion in a third mill, producing a milled fiber material that comprises fiber, starch, and protein;
contacting the milled fiber material with at least one enzyme to convert at least some of the starch therein to dextrose; and
separating the first starch/protein portion into a starch-rich material and a protein-rich material.

24. The process of claim 23, further comprising fermenting the dextrose with a microbe.

25. The process of claim 23, further comprising converting at least some of the dextrose to ethanol by fermentation.

26. The process of claim 23, wherein at least some of the starch in the milled fiber material is at least partially liquefied by alpha amylase and is at least partially saccharified by amyloglucosidase, producing a material comprising dextrose and fiber.

27. The process of claim 26, further comprising separating fiber from dextrose by washing the material that comprises dextrose and fiber with at least one screen, producing a dextrose-depleted fiber material and a dextrose-rich material.

28. The process of claim 27, further comprising at least partially hydrolyzing at least one of cellulose and hemi-cellulose components in the dextrose-depleted fiber material, thereby producing a fiber hydrolysate.

29. The process of claim 28, further comprising fermenting the fiber hydrolysate to produce ethanol.

30. The process of claim 27, further comprising at least partially hydrolyzing at least one of cellulose and hemi-cellulose components in the dextrose-depleted fiber material, thereby producing at least one of dextrose, xylose, or arabinose.

31. (canceled)

32. The process of claim 31, further comprising enzymatically converting at least some of the starch-rich material into dextrose.

33. The process of claim 23, further comprising adding a starch-containing stream to the milled fiber material prior to contacting the milled fiber material with at least one enzyme to convert at least some of the starch therein to dextrose.

34. The process of claim 23, wherein the steeping of corn kernels in an aqueous liquid also produces an aqueous steep liquor that contains protein, and wherein the process further comprises recovering protein from the aqueous steep liquor by membrane filtration.

35. The process of claim 25, wherein the fermentation also produces beer still bottoms, and wherein the process further comprises:
separating fiber from the beer still bottoms, producing a defibered beer still bottoms; and
membrane filtering the defibered beer still bottoms, producing a protein-rich retentate and a permeate.

36. The process of claim 35, further comprising anaerobically digesting the permeate to produce biogas.

37. The process of claim 35, further comprising recovering a protein-rich composition from the retentate.

38. The process of claim 35, further comprising adjusting the pH of the beer still bottoms to about 2-7 before the membrane filtration.

39. The process of claim 35, further comprising adding multivalent cations to the beer still bottoms before the membrane filtration.

40. The process of claim 35, further comprising diafiltering the retentate.

41. A method of recovering protein from beer still bottoms, comprising:
providing a dextrose-containing composition derived from corn;
fermenting the dextrose-containing composition, producing ethanol and beer still bottoms;
separating fiber from the beer still bottoms, producing a defibered beer still bottoms; and
membrane filtering the defibered beer still bottoms, producing a protein-rich retentate and a permeate.

42. The process of claim 41, further comprising recovering a depigmented, protein-rich composition from the retentate.

43. The process of claim 41, further comprising adjusting the pH of the beer still bottoms to about 2-7 before the membrane filtration.

44. The process of claim 41, further comprising adding multivalent cations to the beer still bottoms before the membrane filtration.

45. The process of claim 41, further comprising diafiltering the retentate.

46. The process of claim 41, further comprising anaerobically digesting the permeate to produce biogas.

47. A corn-derived, depigmented protein composition produced by the process of claim 19.

48. A corn-derived, depigmented protein composition produced by the process of claim 37.

49. A corn-derived, depigmented protein composition produced by the process of claim 42.

50. A method of feeding animals, comprising:
feeding a corn-derived, depigmented protein composition produced by the process of claim 19 to an animal.

51. The method of claim 50, wherein the composition further comprises a pigment that affects the coloration of the flesh of the animal that consumes the composition.

52. A method of feeding animals, comprising:
feeding a corn-derived, depigmented protein composition produced by the process of claim 37 to an animal.

53. The method of claim 52, wherein the composition further comprises a pigment that affects the coloration of the flesh of the animal that consumes the composition.

54. A method of feeding animals, comprising:
feeding a corn-derived, depigmented protein composition produced by the process of claim 42 to an animal.

55. The method of claim 54, wherein the composition further comprises a pigment that affects the coloration of the flesh of the animal that consumes the composition.

56. A corn-derived, dextrose-depleted fiber material produced by the process of claim 6.

57. A corn-derived, dextrose-depleted fiber material produced by the process of claim 27.

58. A corn-derived starch liquor produced by the process of claim 5.

59. A corn-derived starch liquor produced by the process of claim 26.

60. The corn-derived starch liquor of claim 59, wherein the liquor is produced by the process of claim 27.
